(19) United States
(12) Patent Application Publication
(10) Pub. No.: US 2017/0195742 A1
(43) Pub. Date: Jul. 6, 2017

(54) APPARATUS AND METHOD FOR PROVIDING BROADCAST SERVICE FOR HYBRID SERVICE USING BROADCAST AND COMMUNICATION CONVERGENCE NETWORKS

(71) Applicant: ELECTRONICS AND TELECOMMUNICATIONS RESEARCH INSTITUTE, Daejeon (KR)

(72) Inventors: Hye-Ju OH, Daejeon (KR); Byung-Jun BAE, Daejeon (KR); Hyun-Jeong YIM, Daejeon (KR); Soon-Choul KIM, Daejeon (KR); Hyoung-Soo LIM, Daejeon (KR); Nam-Ho HUR, Sejong (KR)

(21) Appl. No.: 15/188,943

(22) Filed: Jun. 21, 2016

(30) Foreign Application Priority Data
Jan. 5, 2016 (KR) 10-2016-0001229

(51) Int. Cl. H04N 21/6405; H04N 21/236

(52) U.S. Cl. CPC H04N 21/6405; H04N 21/236

(57) ABSTRACT

Disclosed herein is an apparatus and method for providing a broadcast service. The apparatus for providing a broadcast service includes a segment and metadata creation unit for creating a media segment file and profile information for a broadcast streaming service, a transfer processing unit for performing packetization and configuring a transport session in order to transfer audio/video and data objects, which correspond to the media segment file, and a broadcast transmission unit for formatting a media stream, received from the transfer processing unit, according to a broadcast signal format by multiplexing the media stream based on a layer, for creating a broadcast transmission frame that includes signaling information, and for transmitting the broadcast transmission frame via a broadcast network.

### CROSS REFERENCE TO RELATED APPLICATION

This application claims the benefit of Korean Patent Application No. 10-2016-0001229, filed Jan. 5, 2016, which is hereby incorporated by reference in its entirety into this application.

### BACKGROUND OF THE INVENTION

1. Technical Field

The present invention relates generally to IP-based broadcast and communication convergence networks. More particularly, the present invention relates to a system for providing broadcast content and signaling information on a segment basis and a broadcast service method using devices that configure the system.

2. Description of the Related Art

In order to provide next-generation broadcast service, ATSC 3.0 and DVB-T2 standards address the IP-based delivery of service over a broadcast network and the provision of multimedia services over a hybrid network in which a communication network and a broadcast network are combined.

Multimedia services over a hybrid network are based on IP-based delivery of media, and include the delivery of media based on a segment, which is a data unit that has a content file format and that can be played in isolation, and the provision of service combined with an HTTP-based network transport technique.

For the provision of broadcast services and hybrid services based on IP, the optimized delivery of multimedia content via a broadcast or communication network and the provision of various kinds of supplementary services through such multimedia content delivery are main objects of the next-generation broadcast and communication services.

Currently, in order to provide flexible service in consideration of the characteristics of content or the condition of delivery networks, segment-based media streaming techniques are also applied to broadcast networks. Accordingly, ATSC standards specify ISO Base Media File Format (ISO BMFF), Dynamic Adaptive Streaming over HTTP (DASH) for a communication network, and Real-time Object Delivery over Unidirectional Transport/MPEG Media Transport (ROUTE/MMT) based on UDP for a broadcast network.

Specifically, DASH, used in a communication network, is an adaptive streaming technique for delivering a media segment, requested by a DASH client, using the HTTP protocol. Here, a DASH server functions as an HTTP server and generates media segments and Media Presentation Description (MPD) files, which contain media profile information.

ROUTE is a real-time multicast file transfer protocol which is defined for the real-time delivery of object-based media data and is aligned with a File Delivery over Unidirectional Transport (FLUTE) protocol, which is used in DVB-H and Multimedia Broadcast/Multicast Service (MBMS). ROUTE defines the formats of a source packet and a repair packet, sending and receiving behaviors, and session information and metadata for the delivery of objects.

MPEG Media Transport (MMT) conveys the advantages of MPEG-2 TS and is designed for file transfer over IP networks. Also, in connection with MMT, Media Processing Unit (MPU), MPEG Media Transport Protocol (MMTP), and a data structure that can be used for both storage and packetization are defined. Accordingly, media can be delivered using such a data structure.

When a segment-based media streaming technique is used over a broadcast network in order to provide hybrid service using broadcast and communication convergence networks, it is necessary to segment multimedia content in a broadcast-specific DASH server, to configure a session according to broadcast signaling information, and to deliver media via the broadcast network.

Korean Patent Application Publication No. 2015-0008797 discloses a server in which a broadcast content provision apparatus may provide broadcast content via both a broadcast network and a communication network in a broadcast and communication convergence network environment, but does not mention technology for delivering segmented broadcast content and signaling information.

Therefore, required is new broadcast service technology that may effectively deliver segmented broadcast content and signaling information to a broadcast server.

### SUMMARY OF THE INVENTION

An object of the present invention is to provide an efficient broadcast service by effectively delivering segmented broadcast content and signaling information to a broadcast server when a hybrid service is provided using broadcast and communication convergence networks.

Another object of the present invention is to deliver broadcast content and signaling information between service devices without unnecessary delay or redundancy when segment-based broadcast content is provided through IP-based broadcast and communication convergence networks.

A further object of the present invention is to prevent file transfer from being delayed and to facilitate configuring a dynamic session and multiplexing services, by enabling service devices to send and receive files using a protocol that uses a packet format that is the same as the format of a media packet transferred via a broadcast network.

In order to accomplish the above object, an apparatus for providing a broadcast service according to the present invention includes a segment and metadata creation unit for creating a media segment file and profile information for a broadcast streaming service; a transfer processing unit for performing packetization and configuring a transport session in order to transfer audio/video and data objects, which correspond to the media segment file; and a broadcast transmission unit for formatting a media stream, received from the transfer processing unit, according to a broadcast signal format by multiplexing the media stream based on a layer, for creating a broadcast transmission frame that includes signaling information, and for transmitting the broadcast transmission frame via a broadcast network.

The transfer processing unit may configure a service session, create a packet to be output, which includes metadata for multicast file transfer, and provide the packet to the broadcast transmission unit.

The transfer processing unit may create the packet to be output so as to have a format that is identical to a format of an input packet.

The transfer processing unit may create the packet to be output using pass-through or remultiplexing based on the format of the input packet.

The transfer processing unit may create the metadata for transferring the data object, provide a Forward Error Correction (FEC) function, and configure a session of media segments according to the signaling information.

The transfer processing unit may be one of a ROUTE (Real-Time Object Delivery over Unidirectional Transport) server and a MMT (MPEG Media Transport) server.

The segment and metadata creation unit may transfer the media segment file and the profile information, requested by a client, using a communication protocol via a communication network.

The segment and metadata creation unit may provide the media segment file and the profile information for multicast transfer based on a broadcast protocol.

The apparatus may further include a broadcast media encoding unit for delivering encoded multimedia content to the segment and metadata creation unit, and a broadcast data creation unit for providing broadcast data for a supplementary data service or a disaster broadcast service.

The apparatus may further include a signaling information creation unit for providing broadcast content component information, a program schedule, and signaling data in order to provide a hybrid service.

A method for providing a broadcast service according to an embodiment of the present invention includes creating a media segment file and profile information for a broadcast streaming service; performing packetization and configuring a transport session in order to transfer audio/video and data objects, which correspond to the media segment file; and formatting a media stream, which is generated by packetization, according to a broadcast signal format by multiplexing the media stream based on a layer, and creating a broadcast transmission frame that includes signaling information.

Performing packetization and configuring the transport session may be configured to configure a service session and to create a packet to be output, which includes metadata for multicast file transfer.

Performing packetization and configuring the transport session may be configured to create the packet to be output so as to have a format that is identical to a format of an input packet.

Performing packetization and configuring the transport session may be configured to create the packet to be output using pass-through or remultiplexing based on the format of the input packet.

Performing packetization and configuring the transport session may be configured to create the metadata for transferring the data object, to provide a Forward Error Correction (FEC) function, and to configure a session of media segments according to the signaling information.

Creating the media segment file and the profile information may be configured to transfer the media segment file and the profile information, requested by a client, using a communication protocol via a communication network.

Creating the media segment file and the profile information may be configured to provide the media segment file and the profile information for multicast transfer based on a broadcast protocol.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a broadcast service system according to an embodiment of the present invention;

FIG. 2 is a block diagram illustrating an example of the apparatus for providing a broadcast service, illustrated in FIG. 1;

FIG. 3 is a block diagram illustrating an example of the transfer processing unit illustrated in FIG. 2;

FIG. 4 is a view illustrating the function of the transfer processing unit illustrated in FIG. 2; and

FIG. 5 is a flowchart of a broadcast service method according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

When segmented broadcast content and signaling information are delivered to a broadcast server in order to provide a hybrid service using broadcast and communication convergence networks, the following methods may be used.

The first method is a file-sharing method in which media segments and Media Presentation Description (MPD) files, generated by a DASH server, are shared with a broadcast server. This method may be easily implemented, but has problems related to recognizing file creation and deletion events, locking and unlocking files, aging of file storage, and the like. Also, this method may be unsuitable for real-time streaming.

The second method is one in which a broadcast sending side uses a DASH server and client. This method is advantageous in that a DASH server, used in a communication network, can be used by a broadcast sending side without change. However, because a broadcast server must request a necessary media segment file depending on the result of analysis of the MPD and receive the corresponding file, it requires request and response processes, which are unnecessary in the broadcast network, in which unidirectional media streaming at a constant bitrate is provided according to a broadcast schedule. Also, if a segment is requested by multiple broadcast devices, it is difficult to ensure Quality of Service (QoS).

The present invention proposes technology for delivering broadcast content based on a segment, which may use a DASH server of a communication network and is suitable for a broadcast network, in order to provide a hybrid service using IP-based broadcast and communication convergence networks. Particularly, based on ATSC 3.0 standards, the configuration of a system for delivering segment-based broadcast content over a broadcast network and a method for delivering broadcast content and signaling information between broadcast devices will be described.

Hereinafter, a preferred embodiment of the present invention will be described in detail with reference to the accompanying drawings.

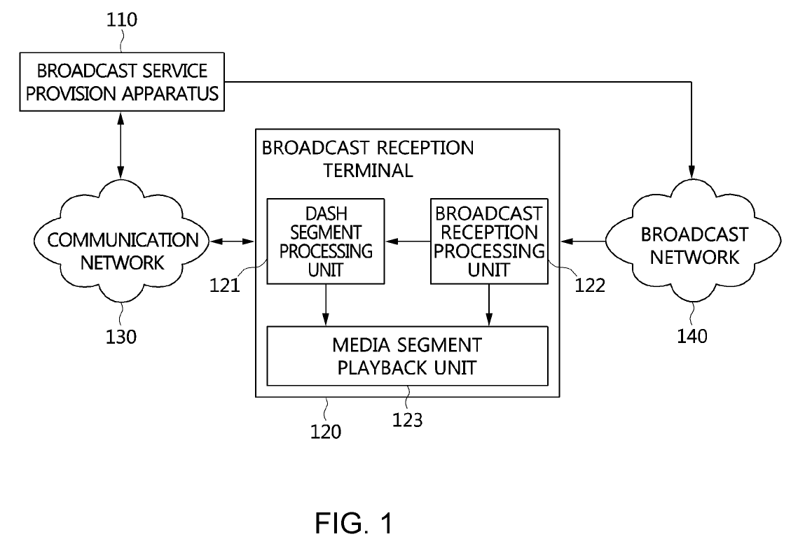

FIG. 1 is a block diagram illustrating a broadcast service system according to an embodiment of the present invention.

Referring to FIG. 1, the broadcast service system according to an embodiment of the present invention includes a broadcast service provision apparatus 110, a broadcast reception terminal 120, a communication network 130, and a broadcast network 140.

The broadcast service provision apparatus 110 provides a broadcast service to the broadcast reception terminal 120 not only via the broadcast network 140 but also via the communication network 130.

For example, ATSC 3.0 standards technology may be applied to the broadcast service system illustrated in FIG. 1. Accordingly, a ROUTE/DASH delivery technique may be applied, and an MMT/MPU delivery technique may also be applied.

In other words, in order to provide a hybrid service using IP-based broadcast and communication convergence networks, the present invention proposes segment-based broadcast content delivery technology, which uses a DASH server of the communication network 130 and is suitable for a broadcast network.

Meanwhile, the broadcast reception terminal 120 may include a DASH segment processing unit 121, a broadcast reception processing unit 122, and a media segment playback unit 123.

The broadcast reception terminal 120 may receive content via the communication network 130 or the broadcast network 140 according to broadcast schedule information. Here, the broadcast reception terminal 120 may dynamically receive a service according to signaling information.

The broadcast reception processing unit 122 acquires the signaling information received via the broadcast network 140 and extracts a media segment by decoding and demultiplexing a broadcast signal using the signaling information.

The DASH segment processing unit 121 extracts a media segment by receiving the media segment and an MPD file, delivered using the HTTP protocol via the communication network 130.

Here, the DASH segment processing unit 121 may be regarded as functioning as a DASH client that requests a segment based on the signaling information from a DASH server and thereby may receive a streaming service.

The media segment playback unit 123 plays the extracted media segment.

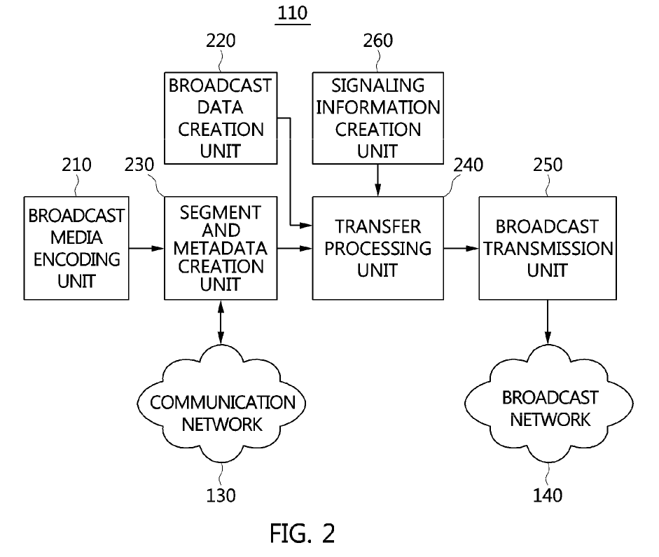

FIG. 2 is a block diagram illustrating an example of the broadcast service provision apparatus illustrated in FIG. 1.

Referring to FIG. 2, the broadcast service provision apparatus, illustrated in FIG. 1, includes a broadcast media encoding unit 210, a broadcast data creation unit 220, a segment and metadata creation unit 230, a transfer processing unit 240, a broadcast transmission unit 250, and a signaling information creation unit 260.

The broadcast media encoding unit 210 delivers encoded multimedia content to the segment and metadata creation unit 230.

The broadcast creation unit 220 provides broadcast data for a supplementary data service or a disaster broadcast service.

The segment and metadata creation unit 230 creates a media segment file and profile information for a broadcast streaming service.

Here, the profile information may be a Media Presentation Description (MPD) file.

The segment and metadata creation unit 230 may deliver a media segment and an MPD file, requested by a DASH client, using the HTTP protocol via the communication network 130 with variable bandwidth.

Meanwhile, the media file segment and the MPD may also be delivered through DASH streaming over the broadcast network 140. Here, DASH streaming is based on UDP-based multicasting, in which the basic concept of broadcasting is implemented.

The signaling information creation unit 260 provides signaling information associated with a broadcast service. That is, the signaling information creation unit 260 creates information about broadcast content components, a program schedule, and signaling data, and provides them to recipients via the communication network 130 or the broadcast network 140, in order to provide a hybrid service.

The transfer processing unit 240 is a device for performing packetization and configuring a transport session in order to transfer audio/video and data objects. Here, the transfer processing unit creates metadata for transferring the object, has a function of Forward Error Correction (FEC), and configures a session of media segments according to the signaling information received from the signaling information creation unit 260.

Here, the transfer processing unit 240 may configure a service session, create a packet to be output, which includes the metadata for multicast file transfer, and provide the created packet to the broadcast transmission unit 250.

Here, the transfer processing unit 240 creates the packet to be output so as to have the same format as an input packet.

Also, the transfer processing unit 240 may create the packet to be output using pass-through or remultiplexing based on the input packet format.

The broadcast transmission unit 250 multiplexes the media stream, received from the transfer processing unit 240, based on a layer so as to have a signal format for mobile broadcast or a signal format for fixed broadcast, configures a broadcast transmission frame by including information about the multiplexed structure and signaling information required for transmission and reception, and transmits the broadcast transmission frame via the broadcast network 140.

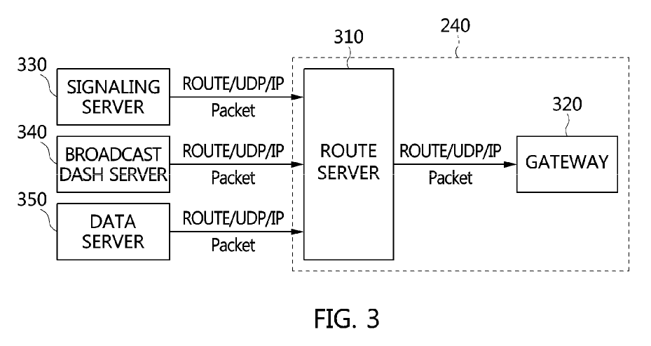

FIG. 3 is a block diagram illustrating an example of the transfer processing unit illustrated in FIG. 2.

Referring to FIG. 3, the transfer processing unit, illustrated in FIG. 2, may include a ROUTE server 310 and a gateway 320.

According to an embodiment of the present invention, a data sending and receiving method is provided in order to deliver segmented media data between the transfer processing unit 240 and other servers 330, 340, and 350 via the broadcast network.

The signaling server 330, the broadcast DASH server 340, and the data server 350, illustrated in FIG. 3, may respectively correspond to the signaling information creation unit 260, the segment and metadata creation unit 230, and the broadcast data creation unit 220, illustrated in FIG. 2.

The transfer processing unit 240 configures a service session using a media segment, a signaling message, and various kinds of broadcast data, and packetizes the service session along with the metadata for multicast file transfer so as to form a packet corresponding to a transport protocol. Then, the transfer processing unit 240 delivers the packet to the broadcast transmission unit.

Here, the input interface of the transfer processing unit 240 may use the same packet format of the file transfer protocol.

The example, illustrated in FIG. 3, shows the transfer processing unit 240 to which the ROUTE/DASH delivery scheme of ATSC 3.0 is applied.

In the example illustrated in FIG. 3, for IP-based multicast file transfer, the transfer processing unit 240 may be a Real-time Object Delivery over Unidirectional Transport (ROUTE) server 310. Also, the gateway 320 may be used for formatting into a broadcast transmission signal format.

Here, the data transfer from the signaling server 330, the broadcast DASH server 340, and the data server 350 to the ROUTE server 310 may also be processed through the multicast file transfer. Therefore, the packet may be received at the ROUTE server 310 using a ROUTE protocol, which is used when the ROUTE server 310 outputs a packet.

Because multiple devices use a protocol having the same packet format as an interface for file transfer therebetween, the transfer processing unit (transport packager) 240 may reuse the received packet in the transmission protocol of the broadcast network and create a session by reconfiguring the values of main parameters.

The metadata for file transfer between the devices may be used selectively according to need, and information about the metadata may be used when the transfer processing unit (transport packager) 240 reuses the received packet or reconfigures the values of the main parameters.

The interface between the devices, that is, the interface between the transfer processing unit (transport packager) 240 and the signaling server 330, the broadcast DASH server 340, or the data server 350, may include UDP/IP based multicast transport protocols (FCAST, FLUTE, ROUTE, MMT, and the like).

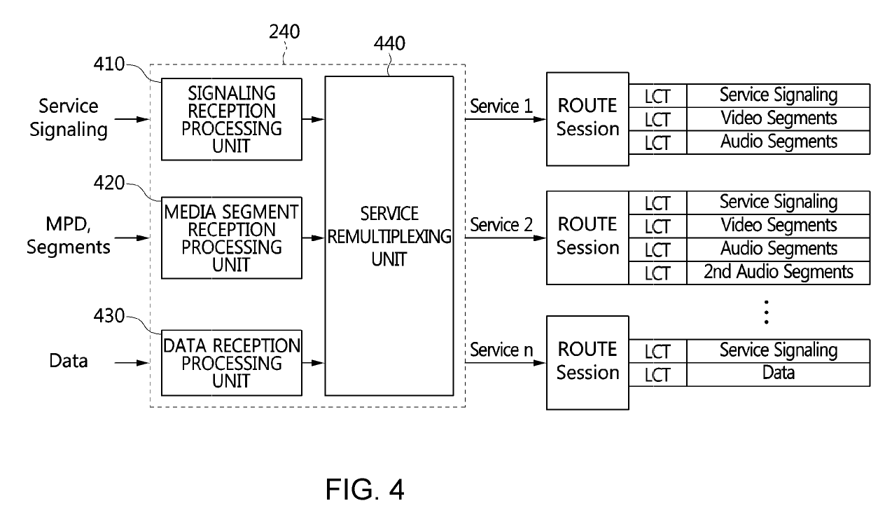

FIG. 4 is a view illustrating the function of the transfer processing unit illustrated in FIG. 2.

Referring to FIG. 4, the transfer processing unit, illustrated in FIG. 2, may include a signaling reception processing unit 410, a media segment reception processing unit 420, a data reception processing unit 430, and a service remultiplexing unit 440.

Particularly, the transfer processing unit 240 of FIG. 4 shows the function of the transfer processing unit in the ROUTE/DASH system.

The signaling reception processing unit 410, the media segment reception processing unit 420, and the data reception processing unit 430 of the transfer processing unit 240 may receive a signaling message, a media segment, and various kinds of broadcast data, which are input from the signaling server, the broadcast DASH server, and the data server.

Also, the transfer processing unit 240 may make the service remultiplexing unit 440 perform functions such as service session management for transmission via the broadcast network, creation of object metadata, multiplexing of a signaling message and a service, and remultiplexing of a media service, input from a plurality of segment and metadata creation units.

Also, the transfer processing unit 240 configures a session based on the service signaling by reconfiguring data of the ROUTE/UDP/IP packet format, received through the input interface, and then outputs it to the broadcast transmission unit.

As described above, because the format of the packet input to the transfer processing unit 240 is the same as the format of the packet output therefrom, the packet received from the signaling server, the broadcast DASH server, and the data server may be used to create a packet to be output using pass-through or remultiplexing depending on the service configuration.

A single ROUTE session is created for a single service, and the single ROUTE session may include a signaling session and multiple video/audio transmission sessions.

As illustrated in FIG. 4, the service may comprise a single audio/video content element, or may comprise multiple audio/video content elements through the addition of a second audio/video content element to the existing audio/video content element.

Also, a supplementary data service may be configured as a single service, or a service may be configured so as to include both audio/video content element and data.

Hitherto, an example in which the ROUTE/DASH system of ATSC 3.0 is used for the transfer processing unit (transport packager) is explained, but without limitation to this example, the present invention may identically be applied to the case in which a similar protocol is used.

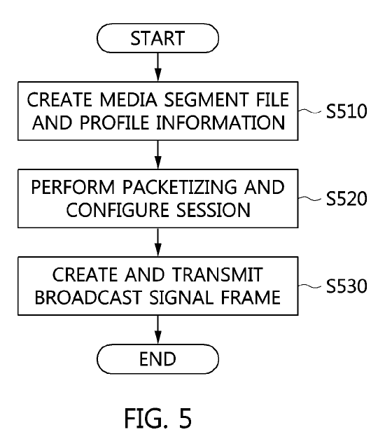

FIG. 5 is a flowchart illustrating a broadcast service method according to an embodiment of the present invention.

Referring to FIG. 5, in the broadcast service method according to an embodiment of the present invention, a media segment file and profile information are created at step S510.

Here, the media segment file and the profile information, requested by a client, may be transferred over a communication network through a communication protocol at step S510.

Here, the media segment file and the profile information may also be provided for multicast transfer based on a broadcast protocol at step S510.

Also, in the broadcast service method according to an embodiment of the present invention, packetization and configuration of a transport session are performed at step S520 in order to transfer audio/video and data objects corresponding to a media segment file.

Here, at step S520, a service session is configured, and a packet to be output, which includes metadata for multicast file transfer, may be created.

Here, the packet to be output may be created so as to have the same format as the input packet at step S520.

Here, at step S520, the packet to be output may be created through pass-through or remultiplexing based on the input packet format.

Here, at step S520, the metadata for transferring the data object are created, an FEC function is provided, and a session of media segments may be configured according to signaling information.

Also, in the broadcast service method according to an embodiment of the present invention, the packetized media stream is formatted according to a broadcast signal format by being multiplexed based on a layer, and a broadcast transmission frame that includes the signaling information is created at step S530.

According to the present invention, in order to provide an IP-based broadcast service using broadcast and communication convergence networks, because the delivery of broadcast content and signaling information between system devices is performed through unidirectional streaming and an interface using the same format of packets transferred over a broadcast network, it is not necessary to request a segment and provide a response thereto. Therefore, delay in transferring a segment attributable to the request and response may be prevented. Also, because packets can be reused by a transport server, session management for dynamic services and file transfer may be easily performed.

As described above, the broadcast service apparatus and method according to the present invention are not limitedly applied to the configurations and operations of the above-described embodiments, but all or some of the embodiments may be selectively combined and configured so that the embodiments may be modified in various ways.

What is claimed is:

1. An apparatus for providing a broadcast service, comprising:
a segment and metadata creation unit for creating a media segment file and profile information for a broadcast streaming service;
a transfer processing unit for performing packetization and configuring a transport session in order to transfer audio/video and data objects, which correspond to the media segment file; and
a broadcast transmission unit for formatting a media stream, received from the transfer processing unit, according to a broadcast signal format by multiplexing the media stream based on a layer, for creating a broadcast transmission frame that includes signaling information, and for transmitting the broadcast transmission frame via a broadcast network.

2. The apparatus of claim 1, wherein the transfer processing unit configures a service session, creates a packet to be output, which includes metadata for multicast file transfer, and provides the packet to the broadcast transmission unit.

3. The apparatus of claim 2, wherein the transfer processing unit creates the packet to be output so as to have a format that is identical to a format of an input packet.

4. The apparatus of claim 3, wherein the transfer processing unit creates the packet to be output using pass-through or remultiplexing based on the format of the input packet.

5. The apparatus of claim 4, wherein the transfer processing unit creates the metadata for transferring the data object, provides a Forward Error Correction (FEC) function, and configures a session of media segments according to the signaling information.

6. The apparatus of claim 5, wherein the transfer processing unit is one of a ROUTE (Real-Time Object Delivery over Unidirectional Transport) server and a MMT (MPEG Media Transport) server.

7. The apparatus of claim 3, wherein the segment and metadata creation unit transfers the media segment file and the profile information, requested by a client, using a communication protocol via a communication network.

8. The apparatus of claim 7, wherein the segment and metadata creation unit provides the media segment file and the profile information for multicast transfer based on a broadcast protocol.

9. The apparatus of claim 3, further comprising:
a broadcast media encoding unit for delivering encoded multimedia content to the segment and metadata creation unit; and
a broadcast data creation unit for providing broadcast data for a supplementary data service or a disaster broadcast service.

10. The apparatus of claim 9, further comprising,
a signaling information creation unit for providing broadcast content component information, a program schedule, and signaling data in order to provide a hybrid service.

11. A method for providing a broadcast service, comprising:
creating a media segment file and profile information for a broadcast streaming service;
performing packetization and configuring a transport session in order to transfer audio/video and data objects, which correspond to the media segment file; and
formatting a media stream, which is generated by packetization, according to a broadcast signal format by multiplexing the media stream based on a layer, and creating a broadcast transmission frame that includes signaling information.

12. The method of claim 11, wherein performing packetization and configuring the transport session is configured to:
configure a service session; and
create a packet to be output, which includes metadata for multicast file transfer.

13. The method of claim 12, wherein performing packetization and configuring the transport session is configured to create the packet to be output so as to have a format that is identical to a format of an input packet.

14. The method of claim 13, wherein performing packetization and configuring the transport session is configured to create the packet to be output using pass-through or remultiplexing based on the format of the input packet.

15. The method of claim 14, wherein performing packetization and configuring the transport session is configured to:
create the metadata for transferring the data object;
provide a Forward Error Correction (FEC) function; and
configure a session of media segments according to the signaling information.

16. The method of claim 13, wherein creating the media segment file and the profile information is configured to transfer the media segment file and the profile information, requested by a client, using a communication protocol via a communication network.

17. The method of claim 16, wherein creating the media segment file and the profile information is configured to provide the media segment file and the profile information for multicast transfer based on a broadcast protocol.
